(19) United States
(12) Patent Application Publication
(10) Pub. No.: US 2005/0205813 A1
(43) Pub. Date: Sep. 22, 2005

(54) Radiation image information recording and reading system

(75) Inventor: Yoshihiro Ishikawa, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/074,778

(22) Filed: Mar. 9, 2005

(30) Foreign Application Priority Data
Mar. 22, 2004 (JP) 2004-083104

(51) Int. Cl. G03B 42/08

(52) U.S. Cl. 250/584

(57) ABSTRACT

An image capturing apparatus acquires ID card information, including a patient ID code, from an ID card carried by a patient, and records the IC card information in an IC chip mounted on a stimulable phosphor panel. The stimulable phosphor panel, in which the IC card information and radiation image information of the patient has been recorded, is stored in a cassette that is loaded into a radiation image information reading apparatus. ID information, which includes patient information corresponding to the patient ID code acquired from the IC chip and exposure information, is acquired from a console. After the radiation image information is read from the stimulable phosphor panel and processed as desired, the radiation image information may be displayed or output in connection with the ID information, and saved.

### BACKGROUND OF THE INVENTION

1. Field of the Invention

The present invention relates to a radiation image information recording and reading system for recording radiation image information of a subject on a stimulable phosphor panel with an image capturing apparatus, and reading the radiation image information from the stimulable phosphor panel with a radiation image information reading apparatus.

2. Description of the Related Art

There has heretofore been known a stimulable phosphor which, when exposed to an applied radiation (X-rays, α-rays, β-rays, γ-rays, electron beams, ultraviolet radiation, or the like), stores part of the energy of the radiation, and, when subsequently exposed to applied stimulating rays such as visible light, emits light in proportion to the stored energy of the radiation.

A radiation image information recording and reading system, which is employed in the art, temporarily records radiation image information of a subject such as a human body on a stimulable phosphor panel having a stimulable phosphor layer. Thereafter, the radiation image information recording and reading system applies stimulating light such as a laser beam or the like to the stimulable phosphor panel to emit light representative of the recorded radiation image information, and then outputs the radiation image information as a visible image on a recording medium such as a photographic photosensitive medium or the like or a display unit such as a CRT or the like, based on an image signal that is generated by photoelectrically reading the light emitted from the stimulable phosphor panel. After the radiation image information has been read from the stimulable phosphor panel, the stimulable phosphor panel is irradiated with erasing light to erase any remaining radiation energy therefrom, and then used again for recording radiation image information thereon.

The above radiation image information recording and reading system is employed in relatively large hospitals. In such hospitals, there is constructed a system for managing radiation image information in association with patient information as subject information, as disclosed in Japanese Laid-Open Patent Publication No. 2002-157585 or Japanese Laid-Open Patent Publication No. 2002-306425, for example. The system will briefly be described below with reference to FIG. 9 of the accompanying drawings.

As shown in FIG. 9, a hospital information system (HIS) 1 for managing overall hospital information is installed in a hospital. The hospital information system 1 has a function to manage patient information, including patient's names, sexes, dates of birth, patient ID codes, etc., and a function to issue ID cards 2 with at least respective patient ID codes recorded thereon.

The hospital also has, installed in a department of radiology, a radiation information system (RIS) 3 for managing overall radiation image information processed by a medical diagnostic image capturing apparatus such as a CT (Computed Tomography) apparatus, an MR (Magnetic Resonance) apparatus, a CR (Computed Radiography) apparatus, or the like.

When an order for acquiring radiation image information from a patient is issued, as instructed by a doctor, the patient goes to the department of radiology, carrying his or her own ID card 2 issued from the HIS 1. In the department of radiology, the radiology technician enters the patient ID code from the console of the RIS 3, using the ID card 2, and also enters exposure information for the acquisition of radiation image information as instructed by the doctor (e.g., an exposure date, an exposed region, an exposure process, etc.) from the console of the RIS 3. In response to the entry of the patient ID code, the RIS 3 requests the HIS 1 to provide necessary patient information based on the patient ID code. The HIS 1 supplies the RIS 3 with the requested patient information.

Then, the radiology technician selects a stimulable phosphor panel IP for recording radiation image information of the patient thereon. After entering a panel identification code into the RIS 3 from a bar code or the like applied to the selected stimulable phosphor panel IP, the radiology technician loads the stimulable phosphor panel IP into an image capturing apparatus 4, which captures and records radiation image information of the patient on the stimulable phosphor panel IP.

The stimulable phosphor panel IP, with the radiation image information of the patient recorded thereon, is then loaded into a radiation image information reading apparatus 5. The radiation image information reading apparatus 5 acquires the panel identification code from the bar code or the like applied to the stimulable phosphor panel IP, and requests the RIS 3 to provide the patient information and the exposure information in association with the panel identification code read by the RIS 3. The RIS 3 retrieves the patient information entered prior to the acquisition of the radiation image information, and also the exposure information based on the panel identification code, and then supplies the patient information and the exposure information to the radiation image information reading apparatus 5.

The radiation image information reading apparatus 5 reads the radiation image information from the stimulable phosphor panel IP, and processes the read radiation image information based on the exposure information supplied from the RIS 3. The processed radiation image information is displayed for medical diagnosis by the doctor, or output to a photographic film or the like, by a desired image display/output apparatus 6 that is indicated depending on the patient information, and is also saved an image saving apparatus 7 in connection with the patient information to.

In the radiation image information recording and reading system thus constructed, a process is performed for successively entering patient ID codes from the ID cards 2 of plural patients into the RIS 3, and also a process is performed for selecting stimulable phosphor panels IP for respective patients and entering the panel identification codes of the stimulable phosphor panels IP into the RIS 3.

When a stimulable phosphor panel IP is loaded into the image capturing apparatus 4, if the patient to be imaged and the stimulable phosphor panel IP are not accurately matched with each other, then there is a possibility that the patient and the stimulable phosphor panel IP may not properly be related to each other. As the exposure information acquired from the RIS 3 according to the panel identification code obtained from the stimulable phosphor panel IP does not correspond to the radiation image information, the radiation image information cannot adequately be processed.

Japanese Laid-Open Patent Publication No. 11-311848 discloses a method of reading patient information and a panel identification code from an IC memory disposed on a cassette, which stores a stimulable phosphor panel, with a radiation image information reading apparatus.

However, even if the disclosed method is applied to the radiation image information recording and reading system shown in FIG. 9, the above problem still occurs if the patent information registered in the IC memory is not accurate.

### SUMMARY OF THE INVENTION

It is a general object of the present invention to provide a radiation image information recording and reading system, which is capable of processing, without trouble, radiation image information obtained from a stimulable phosphor panel.

A major object of the present invention is to provide a radiation image information recording and reading system, which is capable of relating information of a subject and radiation image information obtained from a stimulable phosphor panel properly to each other.

Another object of the present invention is to provide a radiation image information recording and reading system, which is capable of properly processing radiation image information obtained from a stimulable phosphor panel.

In the radiation image information recording and reading system according to the present invention, when a stimulable phosphor panel is loaded into an image capturing apparatus, subject information of a subject is assigned to the stimulable phosphor panel by a subject information assigning unit. When the stimulable phosphor panel, with radiation image information of the subject recorded therein, is loaded into a radiation image information reading apparatus, the subject information assigned to the stimulable phosphor panel is read by a subject information reader, and the radiation image information read from the stimulable phosphor panel is processed in relation to the subject information.

The subject information may be acquired from a subject information holding medium carried by the subject. If the subject information holding medium comprises an IC card such as an RFID card or the like, then the subject information can be acquired from the IC card in a contactless fashion, and can be assigned to the stimulable phosphor panel without transferring the subject information holding medium.

The subject information may be stored in a memory element mounted on the stimulable phosphor panel, or in a memory element mounted on a cassette which stores the stimulable phosphor panel therein. Alternatively, the subject information may be transmitted from a memory element to the subject information reader of the radiation image information reading apparatus in a contactless fashion based on RFID principles.

If the memory element is combined with a radiation shield member for shielding the memory element from a radiation in the image capturing apparatus, then the subject information stored in the memory element is protected from unwanted destruction or erasure.

The radiation image information reading apparatus may have a subject information eraser for erasing the subject information assigned to the stimulable phosphor panel, so that the stimulable phosphor panel can be used again after the radiation image information and the subject information have been erased.

If the subject information is erased from the stimulable phosphor panel, then when an unexposed stimulable phosphor panel with no radiation image information recorded therein, or a stimulable phosphor panel with no subject information registered thereon, is loaded into the radiation image information reading apparatus, the loading of such a stimulable phosphor panel that is not to be read can be brought to the attention of the user of the system.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram of a radiation image information recording and reading system according to an embodiment of the present invention;

FIG. 2 is a schematic perspective view of a radiation information system, including an image capturing apparatus and a radiation image information reading apparatus, which are connected to the radiation information system;

FIG. 3 is a perspective view of a stimulable phosphor panel and a cassette, which are to be loaded into the image capturing apparatus and the radiation image information reading apparatus;

FIG. 4 is a vertical cross-sectional view of the radiation image information reading apparatus;

FIG. 5 is a block diagram of a control system for the radiation information system, including the image capturing apparatus and the radiation image information reading apparatus, which are connected to the radiation information system;

FIG. 6 is a flowchart of a processing sequence of the radiation information system;

FIG. 7 is a flowchart of a processing sequence of the image capturing apparatus;

FIG. 8 is a flowchart of a processing sequence of the radiation image information reading apparatus; and

FIG. 9 is a block diagram of a conventional radiation image information recording and reading system.

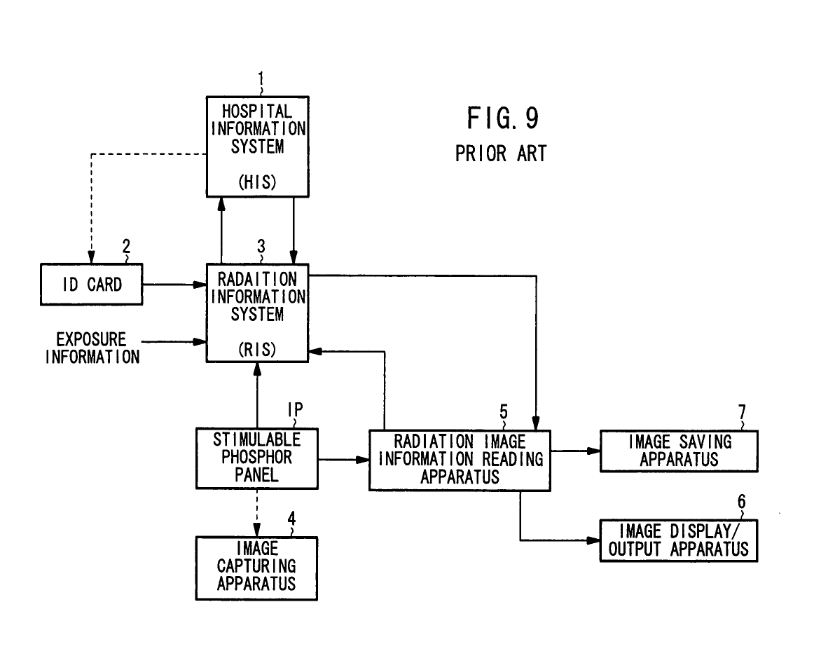

### DESCRIPTION OF THE PREFERRED EMBODIMENT

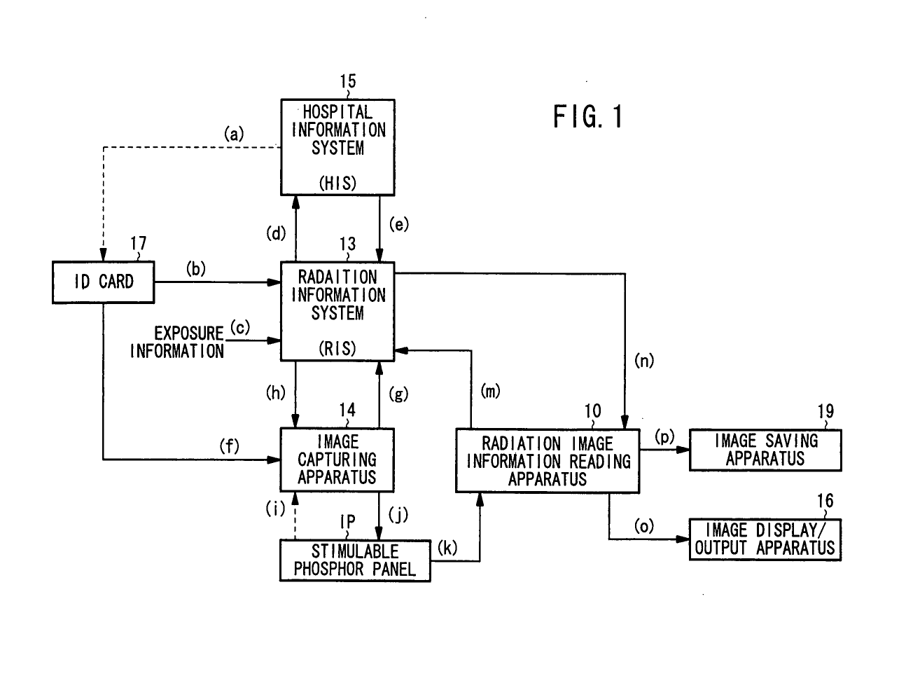

FIG. 1 shows in block form a radiation image information recording and reading system according to an embodiment of the present invention. As shown in FIG. 1, the radiation image information recording and reading system is constructed around a radiation information system (RIS) 13 for managing overall radiation image information. A hospital information system (HIS) 15 for managing overall hospital information is connected as a higher-level system to the RIS 13. The HIS 15 has a function to manage patient information including patient's names, sexes, dates of birth, patient ID codes, etc., and a function to issue ID cards 17 (subject information holding mediums) with at least respective patient ID codes recorded thereon. Each of the ID cards 17 may comprise a contact-type magnetic card or a noncontact-type IC card such as an RFID (Radio Frequency Identification) card or the like.

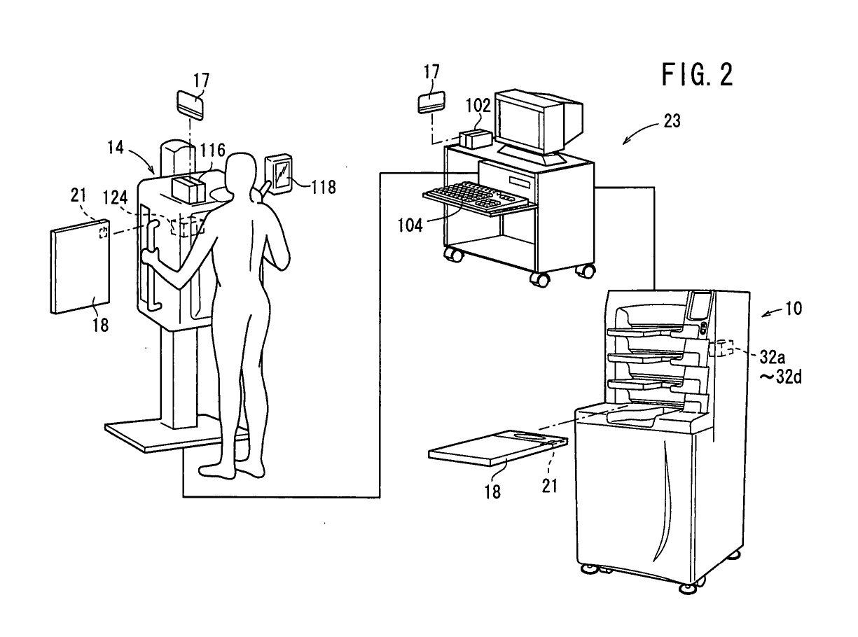

The RIS 13 has a console 23 (see FIG. 2) to which there are connected an image capturing apparatus 14 for capturing radiation image information of a patient and recording the captured radiation image information on a stimulable phosphor panel IP, and a radiation image information recording and reading apparatus 10 for reading radiation image information recorded on the stimulable phosphor panel IP. The operator can enter exposure information as to the acquisition of radiation image information (e.g., an exposure date, an exposed region, an exposure process, etc.) from the console 23. To the radiation image information recording and reading apparatus 10, there are connected an image display/output apparatus 16 for displaying the read radiation image information for medical diagnosis by the doctor, or for outputting the read radiation image information to a photographic film or the like, and an image saving apparatus 19 for saving the radiation image information.

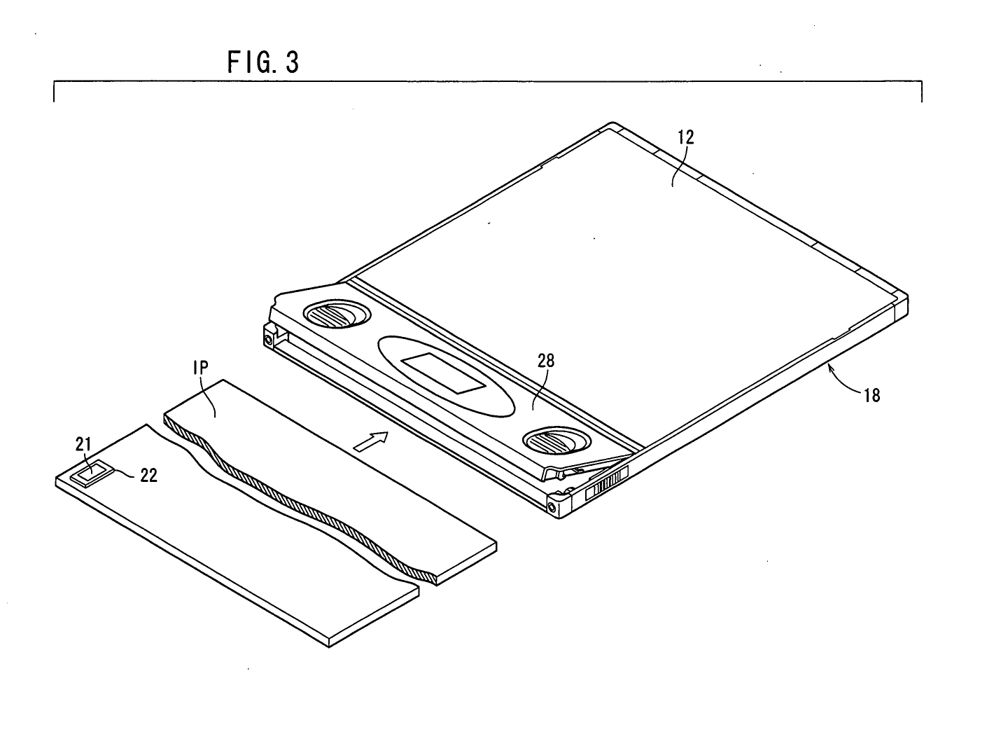

FIG. 3 shows in perspective the stimulable phosphor panel IP and a cassette 18, which are to be loaded into the image capturing apparatus 14 and the radiation image information reading apparatus 10. The cassette 18 comprises a casing 12 for storing the stimulable phosphor panel IP therein and a lid 28 openably and closably hinged to an end of the casing 12. When the lid 28 is opened, the stimulable phosphor panel IP can be placed in the casing 12.

The stimulable phosphor panel IP comprises a flexible panel, and carries an IC chip 21 (memory element), such as an RFID (Radio Frequency Identification) medium or the like for storing a patient ID code read from the ID card 17. A radiation shield member 22, made of a heavy element having an atomic weight of 207 or greater, is disposed between the stimulable phosphor panel IP and the IC chip 21 for preventing the information stored in the IC chip 21 from being destroyed by radiation which would otherwise be applied thereto when the stimulable phosphor panel IP is loaded into the image capturing apparatus 14.

If a certain stimulable phosphor panel IP and a certain cassette 18 are required to be associated with each other, then the IC chip 21 may be applied to the lid 28 of the cassette 18. In this case, the IC chip 21 applied to the lid 28 should preferably be combined with a radiation shield member 22 for protecting the IC chip 21 against exposure to radiation. If the radiation image information reading apparatus 10 has a straight feed path for the stimulable phosphor panel IP, then the stimulable phosphor panel IP may comprise a hard panel having a columnar stimulable phosphor layer evaporated on a support base made of a hard material such as glass or the like.

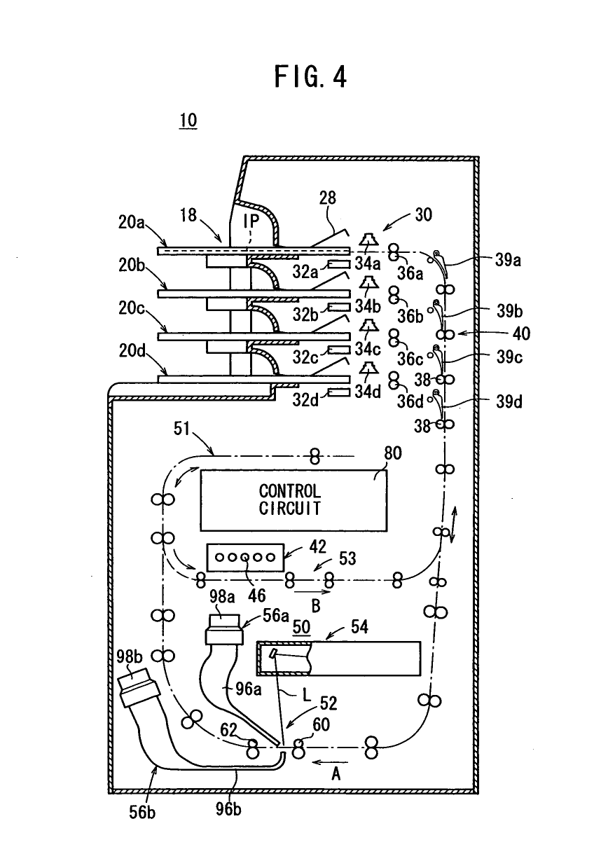

FIG. 4 shows in vertical cross section internal structural details of the radiation image information reading apparatus 10. The radiation image information reading apparatus 10 has in its upper section a plurality of cassette loaders 20a, 20b, 20c, 20d each loaded with a cassette 18 housing therein the stimulable phosphor panel IP. The radiation image information reading apparatus 10 also has a panel feeding/storing mechanism 30 for selectively feeding a stimulable phosphor panel IP from one of the cassettes 18 and storing a stimulable phosphor panel IP into one of the cassettes 18.

The panel feeding/storing mechanism 30 has a plurality of ID information reader/recorders 32a, 32b, 32c, 32d for reading information from and recording information in the respective IC chips 21 on the stimulable phosphor panels IP stored in the cassettes 18 that are loaded in the respective cassette loaders 20a, 20b, 20c, 20d, a plurality of suction cups 34a, 34b, 34c, 34d movable into and out of the respective cassettes 18 when the lids 28 of the cassettes 18 are open, a plurality of feed roller pairs 36a, 36b, 36c, 36d for receiving the respective stimulable phosphor panels IP attracted by the suction cups 34a, 34b, 34c, 34d and feeding them to a feed path 40, and a plurality of swingable guide plates 39a, 39b, 39c, 39d for connecting the feed path 40 to a selected one of the cassette loaders 20a, 20b, 20c, 20d.

The feed path 40, which is connected to the panel feeding/storing mechanism 30, has a plurality of roller pairs 38 and includes a downwardly extending section and a horizontally extending section joined to the lower end of the downwardly extending section. A reader 50 is disposed on the horizontally extending section of the feed path 40. The reader 50 comprises an auxiliary scanning feed mechanism 52 for feeding the stimulable phosphor panel IP in an auxiliary scanning direction indicated by the arrow A, a scanning unit 54 for applying a laser beam L as stimulating light to the stimulable phosphor panel IP as it is being fed in the auxiliary scanning direction indicated by the arrow A, and while deflecting the laser beam L in a main scanning direction that is substantially perpendicular to the auxiliary scanning direction, and a pair of reading units 56a, 56b for photoelectrically reading light emitted from the stimulable phosphor panel IP upon exposure to the laser beam L. The auxiliary scanning feed mechanism 52 has first and second roller pairs 60, 62 for feeding the stimulable phosphor panel IP.

The reading unit 56a, which is disposed above the auxiliary scanning feed mechanism 52, comprises a light guide 96a, having an end disposed along the portion of the stimulable phosphor panel IP which is scanned by the laser beam L, and a photomultiplier 98a mounted on the other end of the light guide 96b. The reading unit 56a collects light emitted from the upper surface of the stimulable phosphor panel IP.

The reading unit 56b, which is disposed below the auxiliary scanning feed mechanism 52, comprises a light guide 96b having an end disposed along the portion of the stimulable phosphor panel IP which is scanned by the laser beam L, and a photomultiplier 98b mounted on the other end of the light guide 96b. If the stimulable phosphor panel IP is of a double-faced type, including a transparent support which allows the recorded radiation image information to be read through both surfaces thereof, then the reading unit 56b collects light emitted from the lower surface of the stimulable phosphor panel IP.

The feed path 40 also includes an upwardly extending section extending from the horizontally extending section, and another horizontally extending section extending from the upper end of the upwardly extending section and connected to a retraction path 51. The retraction path 51 is connected to the downwardly extending section of the feed path 40 through an erasure feed path 53 disposed horizontally above the reader 50. An erasing unit 42 having a horizontal array of erasing light sources 46 is disposed on the erasure feed path 53. A control circuit 80, for controlling the radiation image information recording and reading apparatus 10, is disposed between the erasing unit 42 and the retraction path 51.

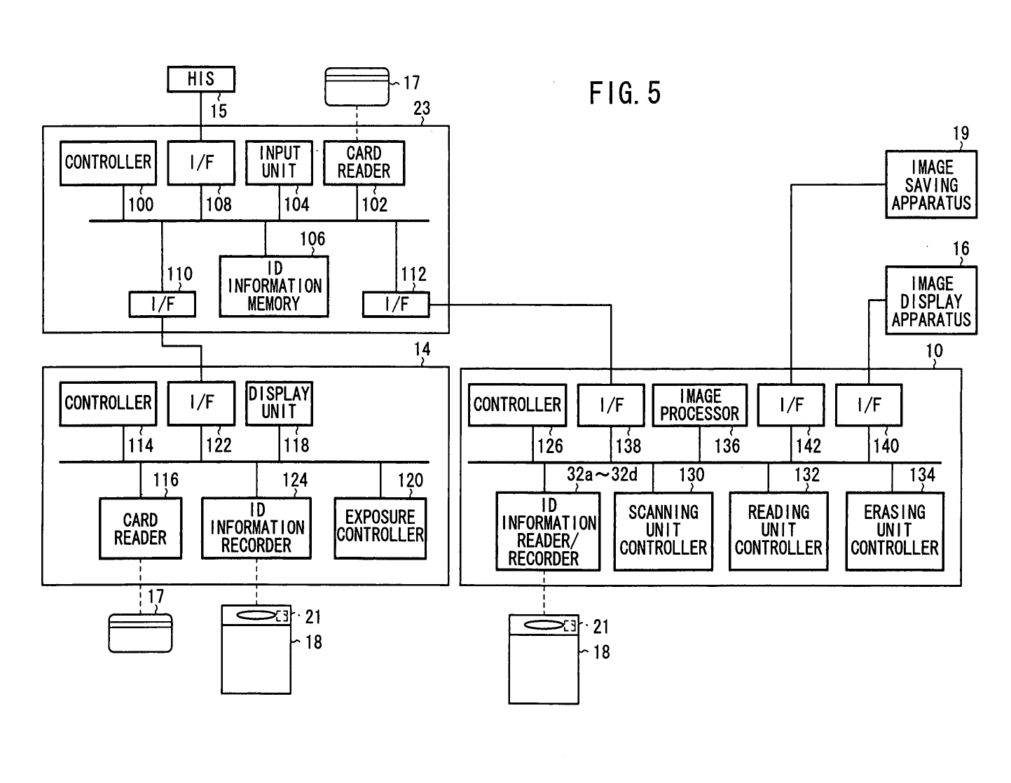

FIG. 5 shows in block form a control system for the console 23 of the RIS 13, together with the image capturing apparatus 14 and the radiation image information reading apparatus 10 which are connected to the console 23.

The console 23 is controlled by a controller 100 that is connected to a card reader 102 for reading ID card information, including the patient ID code recorded in the ID card 17, an input unit 104 for entering necessary information including exposure information, and an ID information memory 106 for storing patient ID information and exposure information. The console 23 also has interfaces (I/Fs) 108, 110, 112 for transferring information to and from the HIS 15, the image capturing apparatus 14, and the radiation image information recording and reading apparatus 10.

The image capturing apparatus 14 is controlled by a controller 114 that is connected to a card reader 116 for reading the patient ID code recorded in the ID card 17, a display unit 118 for displaying patient information such as a patient's name based on the read patient ID code and exposure information, an exposure controller 120 for controlling an image capturing process performed by the image capturing apparatus 14, an interface (I/F) 122 for acquiring patient ID information from the console 23 through the interface (I/F) 110 thereof, and an ID information recorder (subject information assigning unit) 124 for recording ID information in the IC chip 21 on the stimulable phosphor panel IP that is stored in a loaded cassette 18.

The radiation image information reading apparatus 10 is controlled by a controller 126 that is connected to a plurality of ID information reader/recorders (subject information readers, subject information erasers) 32a, 32b, 32c, 32d, for reading necessary ID information from the IC chips on the stimulable phosphor panels IP that are stored in the respective loaded cassettes 18, for recording necessary information in the IC chips on the stimulable phosphor panels IP from which the radiation image information has been read, and for erasing unnecessary ID information recorded in the IC chips 21. The controller 126 is also connected to a scanning unit controller 130 for controlling the scanning unit 54, a reading unit controller 132 for controlling the reading units 56a, 56b, an erasing unit controller 134 for controlling the erasing unit 42, and an image processor (radiation image information processor) 136 for processing the radiation image information read from the stimulable phosphor panels IP. The radiation image information reading apparatus 10 also has interfaces (I/Fs) 138, 140, 142 for transferring information to and from the console 23, the image display/output apparatus 16, and the image saving apparatus 19.

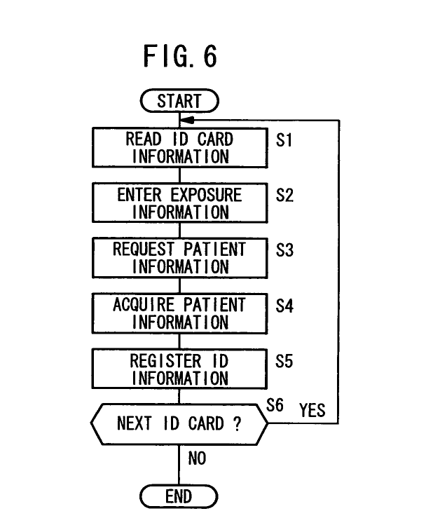

The radiation image information recording and reading system according to the embodiment of the present invention is basically constructed as described above. Operation of the radiation image information recording and reading system will be described below with reference to FIGS. 6 through 8.

First, the HIS 15 registers patient information including the patient's name, sex, date of birth, and a patient ID code or the like, for identifying the patient, and issues an ID card 17, having recorded therein ID card information including the patient ID code, to the patient ((a) in FIG. 1). When an order for acquiring radiation image information from the patient is issued during a diagnostic process in an interview with a doctor, the patient may be sent to the department of radiology, carrying his or her own ID card 17 issued from the HIS 15.

In the department of radiology, the radiology technician operates the console 23 of the RIS 13 to read the ID card information, including the patient ID code from the ID card 17 carried by the patient, with the card reader 102 in step S1 in FIG. 6 ((b) in FIG. 1). The radiology technician also enters exposure information as to the acquisition of radiation image information, as instructed by the doctor (e.g., an exposure date, an exposed region, an exposure process, etc.) from the input unit 104 of the console 23 in step S2 ((c) in FIG. 1).

The RIS 13 transmits the patient ID code acquired from the ID card 17 to the HIS 15, requesting the HIS 15 to supply necessary patient information including the patient's name in step S3 ((d) in FIG. 1). Based on the patient ID code, the HIS 15 retrieves the corresponding patient information and sends the patient information to the RIS 13. The RIS 13 acquires the patient information from the HIS 15 in step S4 ((e) in FIG. 1), and registers the patient information and the exposure information entered in step S2 as ID information in the ID information memory 106 in step S5.

If the doctor has registered the exposure information in the HIS 15, then the radiology technician is not required to register the exposure information, but can acquire the exposure information from the HIS 15 based on the patient ID code.

If there are several patients whose radiation image information needs to be acquired, then the radiology technician repeatedly registers ID information using the ID cards 17 of the patients in step S6.

Then, the patient goes to the image capturing apparatus 14, and has the card reader 116 read the ID card information registered in the ID card 17 carried by the patient. If the ID card 17 is a noncontact-type IC card, such as an RFID card or the like, then the ID card information registered in the ID card 17 can automatically be read by the card reader 116 without the need for the patient to do anything in order for the card reader 116 to read the ID card 17.

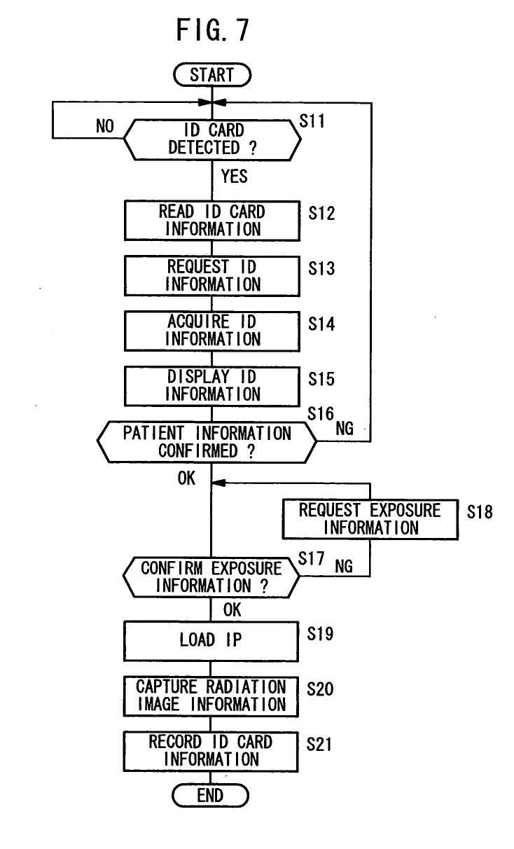

When the card reader 116 detects the ID card 17 in step S11 in FIG. 7, the card reader 116 reads the registered ID card information in step S12 ((f) in FIG. 1), and transmits the patient ID code contained in the ID card information to the RIS 13, to request necessary ID information therefrom in step S13 ((g) in FIG. 1). Based on the patient ID code, the RIS 13 retrieves the corresponding ID information from the ID information memory 106, and sends the ID information to the image capturing apparatus 14. The image capturing apparatus 14 acquires the ID information in step S14 ((h) in FIG. 1), and displays the contents of the ID information on the display unit 118 in step S15.

The radiology technician and/or the patient confirms the patient information and the exposure information that are displayed on the display unit 118 in steps S16 and S17. At this time, if the displayed patient's name and the name of the patient do not match, then this is an indication that the ID card 17 carried by the patient or the registered patient information may possibly have some trouble. Further, if the displayed exposure information is different from the exposure information indicated by the doctor, then the exposure information entered from the console 23 may possibly be wrong. If such problems are identified and confirmed, then the ID card 17 or the registered patient information may be corrected, and then the patient information and exposure information are confirmed again in steps S16 and S17. If the patient information is correct, but the exposure information is in error, then the console 23 of the RIS 13 is requested to provide correct exposure information in step S18. According to this request, the radiology technician enters information to correct the exposure information.

If ID information from the HIS 15 and the RIS 13 is displayed on the display unit 118 of the image capturing apparatus 14 according to an order from the doctor, then when the patient ID code read by the card reader 116 and the patient ID code of the ID information sent from the RIS 13 to the image capturing apparatus 14 do not agree with each other, then a warning may be issued by the console 23 of the RIS 13 or by the image capturing apparatus 14.

If both the patient information and the exposure information are confirmed as being correct, then the radiology technician loads a stimulable phosphor panel IP, corresponding to the exposure information displayed on the display unit 118, into the image capturing apparatus 14 in step S19 ((i) in FIG. 1), and radiation image information of the patient is captured and recorded on the stimulable phosphor panel IP in accordance with the exposure information in step S20.

When capturing of the radiation image information is finished, the ID information recorder 124 records ID card information, including the patient ID code acquired in step S14, in the IC chip 21 attached to the stimulable phosphor panel IP in step S21 ((j) in FIG. 1). At this time, the ID card information recorded in the IC chip 21 and the information of the patient whose radiation image information has been recorded in the stimulable phosphor panel IP fully agree with each other.

All ID information, including the patient information and the exposure information, may be recorded in the IC chip 21. Image processing conditions may be acquired from the RIS 13 and recorded in the IC chip 21 for use in an image processing process performed by the radiation image information recording and reading apparatus 10.

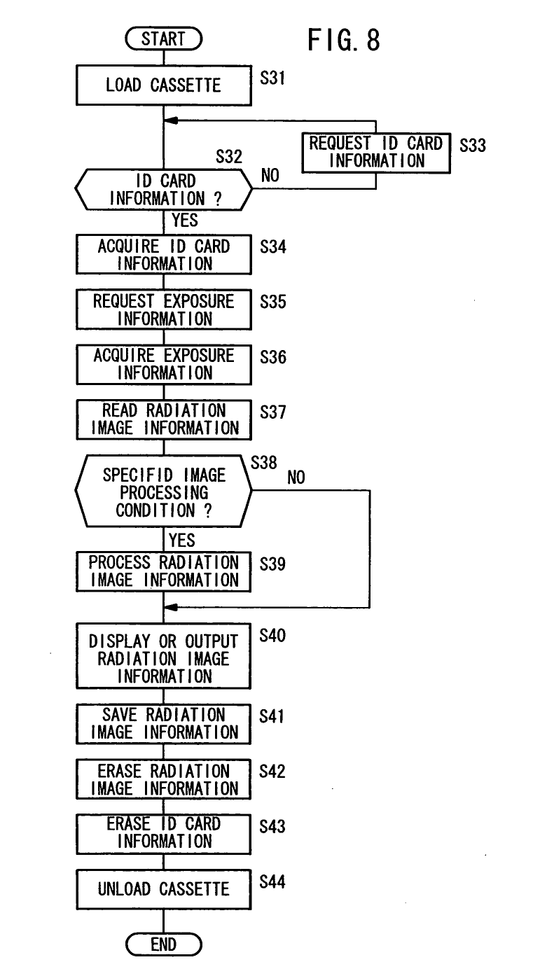

Then, the radiology technician removes the cassette 18, which stores the stimulable phosphor panel IP with the radiation image information recorded therein, from the image capturing apparatus 14, and loads the removed cassette 18 into one of the cassette loaders 20a, 20b, 20c, 20d of the radiation image information recording and reading apparatus 10 in step S31 in FIG. 8.

When the cassette 18 is loaded, a corresponding one of the ID information reader/recorders 32a, 32b, 32c, 32d in the panel feeding/storing mechanism 30 reads the ID card information from the IC chip 21 attached to the stimulable phosphor panel IP in step S32. If no IC chip is attached to the stimulable phosphor panel IP, or the IC chip 21 attached to the stimulable phosphor panel IP does not have any IC card information recorded therein, then the console 23 is requested to provide ID card information in step S33.

After ID card information is acquired from the IC chip 21 or the console 23 in step S34 ((k)) in FIG. 1), the radiation image information recording and reading apparatus 10 requests the RIS 13 to provide exposure information based on the patient ID code included in the ID card information in step S35 ((m)) in FIG. 1). Based on the patient ID code sent from the radiation image information recording and reading apparatus 10, the RIS 13 retrieves the corresponding exposure information from the ID information memory 106, and sends the retrieved exposure information to the radiation image information recording and reading apparatus 10. Having acquired the exposure information in step S36 ((n) in FIG. 1), the radiation image information recording and reading apparatus 10 starts a process of reading the radiation image information recorded in the stimulable phosphor panel IP in step S37.

Specifically, the lid 28 of the cassette 18 is opened by a lid opening mechanism (not shown), and then a corresponding one of the suction cups 34a, 34b, 34c, 34d in the panel feeding/storing mechanism 30 is moved into the cassette 18. The suction cup attracts the stimulable phosphor panel IP in the cassette 18. The suction cup is moved out of the cassette 18, removing therewith the stimulable phosphor panel IP from the cassette 18, and transferring the stimulable phosphor panel IP to a corresponding one of the feed roller pairs 36a, 36b, 36c, 36d.

The feed roller pair grips the stimulable phosphor panel IP and supplies the stimulable phosphor panel IP to the feed path 40. The roller pairs 38 are rotated to feed the stimulable phosphor panel IP down the feed path 40 until the stimulable phosphor panel IP reaches the auxiliary scanning feed mechanism 52 of the reader 50.

In the auxiliary scanning feed mechanism 52, the stimulable phosphor panel IP is fed horizontally in the auxiliary scanning direction indicated by the arrow A by the first and second roller pairs 60, 62. At the same time, the scanning unit 54 applies the laser beam L to the stimulable phosphor panel IP to scan the stimulable phosphor panel IP in the main scanning direction. Application of the laser beam L causes the stimulable phosphor panel IP to emit light representative of the recorded radiation image information. The emitted light is guided by the light guides 96a, 96b and photoelectrically read by the photomultipliers 98a, 98b.

If the exposure information acquired in step S36 includes a specified image processing condition in step S38, then the image processor 136 processes the radiation image information that has been read from the stimulable phosphor panel IP in step S39. If the IC chip 21 stores all ID information, including the patient information and the exposure information, and the ID information is read from the IC chip 21 by a corresponding one of the ID information reader/recorders 32a, 32b, 32c, 32d, then the radiation image information may be processed without acquiring the exposure information from the RIS 13.

If the ID information includes a specified output destination such as the image display/output apparatus 16 or a photographic film, then the radiation image information recording and reading apparatus 10 displays the radiation image information, processed if necessary, on the image display/output apparatus 16, or outputs the radiation image information, processed if necessary, to a photographic film for medical diagnosis by the doctor in step S40 ((o) in FIG. 1). The radiation image information is also sent to the image saving apparatus 19, which saves the radiation image information in step S41 ((p) in FIG. 1).

After the recorded radiation image information is read from the stimulable phosphor panel IP, the stimulable phosphor panel IP is fed along the upwardly extending section of the feed path 40 into the retraction path 51, and then is fed into the erasure feed path 53. As the stimulable phosphor panel IP is fed along the erasure feed path 53 in the direction indicated by the arrow B, the erasing light sources 46 of the erasing unit 42 apply erasing light to the stimulable phosphor panel IP, erasing any remaining radiation image information from the stimulable phosphor panel IP in step S42.

The stimulable phosphor panel IP from which the remaining radiation image information has been erased is fed from the erasure feed path 53 into the downwardly extending section of the feed path 40, after which the stimulable phosphor panel IP is returned along a selected one of the guide plates 39a, 39b, 39c, 39d into the corresponding cassette 18 by the panel feeding/storing mechanism 30.

At this time, a corresponding one of the ID information reader/recorders 32a, 32b, 32c, 32d erases the ID card information recorded in the IC chip 21 on the stimulable phosphor panel IP in step S43. Radiation dose information, which is calculated from the radiation image information which is read from the stimulable phosphor panel IP, may be recorded in the IC chip 21 and used as a basis for determining whether the stimulable phosphor panel IP is deteriorated or not.

Then, the lid 28 of the cassette 18 which has stored the stimulable phosphor panel IP therein is closed, and the cassette 18 is unloaded from a corresponding one of the cassette loaders 20a, 20b, 20c, 20d in step S44. The stimulable phosphor panel IP stored in the cassette 18 will be used again in the process of capturing and recording radiation image information.

Although a certain preferred embodiment of the present invention has been shown and described in detail, it should be understood that various changes and modifications may be made therein without departing from the scope of the appended claims.

1. A radiation image information recording and reading system for recording and reading radiation image information of a subject, comprising:
an image capturing apparatus for recording radiation image information on a stimulable phosphor panel; and
a radiation image information reading apparatus for reading the recorded radiation image information from the stimulable phosphor panel;
said image capturing apparatus including:
a subject information assigning unit for assigning subject information of the subject to said stimulable phosphor panel;
said radiation image information reading apparatus including:
a subject information reader for reading said subject information assigned to said stimulable phosphor panel; and
a radiation image information processor for processing the recorded radiation image information read from the stimulable phosphor panel in relation to said subject information.

2. A radiation image information recording and reading system according to claim 1, wherein said image capturing apparatus includes:
a subject information acquiring unit for acquiring said subject information from a subject information holding medium carried by said subject.

3. A radiation image information recording and reading system according to claim 2, wherein said subject information acquiring unit acquires said subject information from said subject information holding medium in a contactless fashion.

4. A radiation image information recording and reading system according to claim 1, wherein said image capturing apparatus includes:
a subject information display unit for displaying said subject information.

5. A radiation image information recording and reading system according to claim 1, wherein said subject information assigning unit assigns said subject information to said stimulable phosphor panel in a contactless fashion.

6. A radiation image information recording and reading system according to claim 1, wherein said stimulable phosphor panel has a memory element disposed thereon for storing said subject information assigned by said subject information assigning unit.

7. A radiation image information recording and reading system according to claim 6, wherein said subject information reader reads said subject information in a contactless fashion from said memory element disposed on said stimulable phosphor panel.

8. A radiation image information recording and reading system according to claim 6, wherein said memory element is combined with a shield member for shielding the memory element from radiation applied in said image capturing apparatus.

9. A radiation image information recording and reading system according to claim 1, wherein said stimulable phosphor panel is stored in a cassette and supplied to said image capturing apparatus, said cassette having a memory element disposed thereon for storing said subject information.

10. A radiation image information recording and reading system according to claim 9, wherein said subject information reader reads said subject information in a contactless fashion from said memory element disposed on said cassette.

11. A radiation image information recording and reading system according to claim 9, wherein said memory element is combined with a shield member for shielding the memory element from radiation applied in said image capturing apparatus.

12. A radiation image information recording and reading system according to claim 1, wherein said radiation image information reading apparatus includes:
a subject information eraser for erasing said subject information assigned to said stimulable phosphor panel.
